(19) United States
(12) Patent Application Publication
(10) Pub. No.: US 2023/0180339 A1
(43) Pub. Date: Jun. 8, 2023

(54) NETWORK CONTROL DEVICE, NETWORK CONTROL METHOD, AND PROGRAM

(71) Applicant: SONY GROUP CORPORATION, TOKYO (JP)

(72) Inventors: HIROAKI TAKANO, TOKYO (JP); HIROFUMI KASAI, TOKYO (JP); TOMOAKI MATSUMURA, TOKYO (JP)

(21) Appl. No.: 17/906,716

(22) PCT Filed: Feb. 3, 2021
(86) PCT No.: PCT/JP2021/003832

§ 371 Date: Sep. 19, 2022

(30) Foreign Application Priority Data
Mar. 25, 2020 (JP) 2020-054559

(51) Int. Cl. H04W 76/22; H04W 76/12

(52) U.S. Cl. CPC H04W 76/22; H04W 76/12

(57) ABSTRACT

The present technology relates to a network control device to flexibly control, at low cost, allocation of a user plane to a terminal in order to secure throughput according to the number of terminals in a network. The network control device includes a setting information holding unit and a control unit. The setting information holding unit holds, for each terminal, setting information including setting of a correspondence relationship with a user plane of a network. The control unit controls, after the setting of a correspondence relationship between a terminal and a user plane is changed, the network with the setting reflected under a predetermined condition.

### TECHNICAL FIELD

The present technology relates to a network control device. Specifically, the present technology relates to a network control device that controls allocation of terminals and network resources, a processing method thereof, and a program for causing a computer to execute the method.

### BACKGROUND ART

A cellular network includes a radio access network (RAN) and a core network (CN). The RAN is a wireless system between a base station (BS) and a terminal (user equipment: UE). The core network mainly performs permission and session management for a case where a terminal connects to a network. In 4G and 5G, the core network includes a control plane function (CPF) and a user plane function (UPF). In a case where the terminal is connected to the network to send and receive data, the user plane function of the core network is required. In the case of 4G, an SGW and a PGW play the role. In the case of 5G, the user plane function plays the role.

In order to allocate a user plane to a terminal, in 4G, a selection function determines which SGW and PGW are to be allocated to a terminal that has attached to the network depending on the network conditions at the time. Then, on the basis of the information, as a request from an MME, an earthen pipe called a GTP tunnel is provided between the base station and the SGW and the PGW. Here, the PGW is selected on the basis of an APN set by the terminal. Further, the SGW is selected according to the geographical location of the terminal (see, for example, Non-Patent Document 1.).

Further, in 5G, information called network slice selection assistance information (NSSAI) is provided to the terminal, and which network slice is selectable is provided to the terminal. A network slice selection function (NSSF) allocates a user plane function corresponding to a network slice selected by the terminal to the terminal (see, for example, Non-Patent Document 2.).

### CITATION LIST

### Non-Patent Document

Non-Patent Document 1: 3GPP TS 23.401, Section 4.3.8
Non-Patent Document 2: 3GPP TS 23.501, Section 5.15

### SUMMARY OF THE INVENTION

### Problems to be Solved by the Invention

In the conventional technology described above, in order to secure throughput according to the number of terminals, it is useful to prepare a plurality of user planes and allocate the user planes to the terminals as necessary. However, in the foregoing conventional technology, it is difficult to flexibly allocate the user planes to the terminals. In particular, a core network for a local cellular system in recent years needs to be implemented at low cost, and providing a complicated mechanism is not preferable.

The present technology has been made in view of such a situation, and an object thereof is to flexibly control allocation of a user plane to a terminal.

### Solutions to Problems

The present technology has been made to solve the above-described problems, and a first aspect thereof is a network control device including a setting information holding unit configured to hold, for each terminal, setting information including setting of a correspondence relationship with a user plane of a network, and a control unit configured to control, after the setting is changed, the network with the setting reflected under a predetermined condition, a control method thereof, and a program. The configuration produces an effect that, after the setting of the correspondence relationship between the terminal and the user plane is changed, the setting thus changed is reflected under a predetermined condition.

Further, in the first aspect, the change in the setting is to newly allocate the user plane to the terminal, and the control unit may reflect the setting in a case where the terminal performs a predetermined operation. For example, the control unit may reflect the setting in a case where the terminal performs an attaching operation and a PDU session is generated.

Further, in the first aspect, the control unit may read the setting information from the setting information holding unit at predetermined timing to hold the setting information in an internal memory, and reflect the setting under the predetermined condition on the basis of the setting information held in the internal memory. The configuration produces an effect of reflecting the setting of the correspondence relationship between the terminal and the user plane on the basis of the setting information held in the internal memory. In this case, the control unit may read the setting information from the setting information holding unit at a constant cycle to hold the setting information in the internal memory.

Further, in the first aspect, the control unit may read only a part corresponding to the setting of the setting information from the setting information holding unit at the constant cycle to hold the part corresponding to the setting in the internal memory. The configuration produces an effect of minimizing the information held in the internal memory.

Further, in the first aspect, after resources of the user plane are increased, the setting information holding unit may hold the setting of allocating the user plane increased to the terminal. The configuration produces an effect of reflecting the setting after the resources of the user plane are increased.

Further, in the first aspect, resources of the user plane may be distributed and deployed in a first information processing device in a local area network and a second information processing device on the Internet, and the first and second information processing devices may be connected via a wide area layer-2. The configuration produces an effect of forming a system across on-premises and on-cloud. In this case, the first and second information processing devices may be networked via an identical subnet.

Further, in the first aspect, after a certain period of time has elapsed since deletion of a user plane allocated in the setting held in the setting information holding unit, the control unit may delete resources of the user plane. The configuration produces an effect of easily deleting the resources of the user plane without receiving a notification of detachment of the terminal.

Further, in the first aspect, before deleting the resources of the user plane, the control unit may inform the terminal that the resources of the user plane are to be deleted. The configuration produces an effect of avoiding unintended communication interception in the terminal.

Further, in the first aspect, the setting information holding unit may hold setting of a correspondence relationship with the terminal on the basis of conditions regarding deletion of the user plane. The configuration produces an effect of allocating the terminal to the user plane that satisfies conditions regarding the deletion.

Further, in the first aspect, the control unit may delete allocation of the user plane every time the terminal restarts a communication function at regular time intervals. The configuration produces an effect of, in a case where the communication function is restarted by an application or the like for turning off/on an airplane mode in the terminal, deleting the allocation of the user plane.

### BRIEF DESCRIPTION OF DRAWINGS

FIG. 1 is a diagram illustrating a first example of a wireless communication system assumed in an embodiment of the present technology.

FIG. 2 is a diagram illustrating a second example of a wireless communication system assumed in an embodiment of the present technology.

FIG. 3 is a diagram illustrating an example of core network deployment according to an embodiment of the present technology.

FIG. 4 is a diagram illustrating an example of a case where a core network is a bottleneck.

FIG. 5 is a diagram illustrating an example in which a user plane is scaled in an embodiment of the present technology.

FIG. 6 is a diagram illustrating an example of dynamic scaling according to an embodiment of the present technology.

FIG. 7 is a diagram illustrating an example of a setting file 118 according to an embodiment of the present technology.

FIG. 8 is a diagram illustrating an example of basic subscriber information of the setting file 118 according to an embodiment of the present technology.

FIG. 9 is a diagram illustrating an example of a start state of a UPF set according to an embodiment of the present technology.

FIG. 10 is a diagram illustrating an example of an aspect of traffic monitoring by a resource management function 190 according to an embodiment of the present technology.

FIG. 11 is a diagram illustrating an example of operation timing of a wireless communication system according to an embodiment of the present technology.

FIG. 12 is a diagram illustrating another example of operation timing of a wireless communication system according to an embodiment of the present technology.

FIG. 13 is a sequence diagram illustrating an example of an operation flow of a wireless communication system according to an embodiment of the present technology.

FIG. 14 is a sequence diagram illustrating another example of an operation flow of a wireless communication system according to an embodiment of the present technology.

FIG. 15 is a diagram illustrating an example of a wireless communication system according to a first modification example to an embodiment of the present technology.

FIG. 16 is a sequence diagram illustrating an example of an operation flow of a wireless communication system according to a second modification example to an embodiment of the present technology.

FIG. 17 is a diagram illustrating an example of a message to a user in a second modification example to an embodiment of the present technology.

FIG. 18 is a diagram illustrating an example of priority of UPF sets in a third modification example to an embodiment of the present technology.

### MODE FOR CARRYING OUT THE INVENTION

A mode for carrying out the present technology (hereinafter, referred to as an embodiment) is described below. The description is given in the following order.

1. Embodiment

2. Modification Example

### 1. EMBODIMENT

[Wireless Communication System]

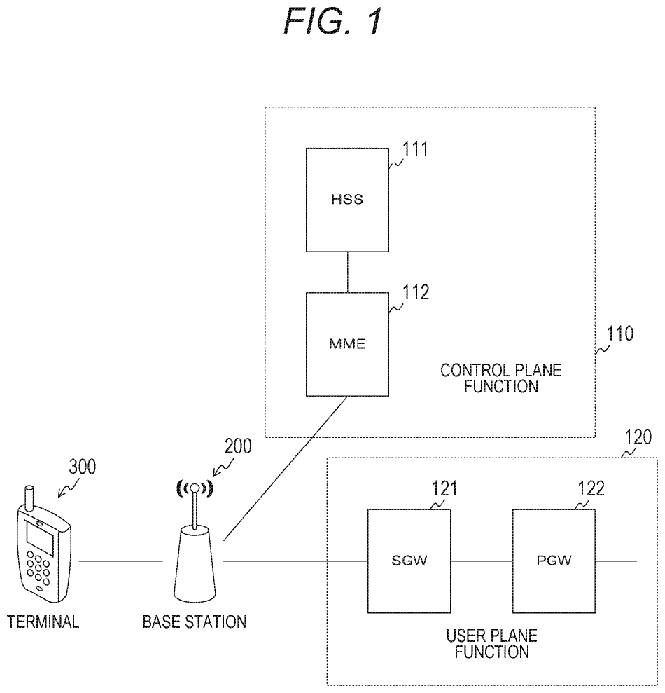

FIG. 1 is a diagram illustrating a first example of the wireless communication system assumed in the embodiment of the present technology.

The first example is an example of a case where the embodiment of the present technology is applied to a fourth-generation mobile communication system (4G). A terminal 300 is connected to a core network via a base station 200. The terminal 300 and the base station 200 are connected by a RAN which is a wireless system.

The core network mainly performs permission and session management for a case where the terminal 300 is connected to a network, and is referred to as an evolved packet core (EPC) in 4G. The 4G core network is divided into a control plane function 110 and a user plane function 120, and the former controls the network and the latter performs packet transfer. Note that the control plane function 110 is an example of a control unit described in the claims. Further, hereinafter, the control plane function 110 may be simply abbreviated as a control plane. Similarly, the user plane function 120 may be simply abbreviated as a user plane.

The 4G control plane function 110 includes an HSS 111, an MME 112, and the like. The home subscriber server (HSS) 111 is a database server that manages user information. The mobility management entity (MME) 112 is a gateway of a control signal for controlling the terminal 300.

The 4G user plane function 120 includes an SGW 121, a PGW 122, and the like. The serving gateway (SGW) 121 is a gateway of user data. The packet data network gateway (PGW) 122 is a gateway for connecting to an external network.

In 4G, contract information of the terminal 300 and a key for encryption are received from the HSS 111 in which subscriber information of the terminal 300 is stored, and a determination is made as to whether or not the terminal 300 is allowed to connect to the network, and the key for encryption is generated, for example. That is, in order for the terminal 300 to connect to the network, it is necessary that the HSS 111 stores information regarding the terminal 300 correlated with a subscriber number called international mobile subscriber identity (IMSI) in a subscriber identity module (SIM) card of the terminal 300. Further, the MME 112 plays a role for the terminal 300 to attach to the cellular system.

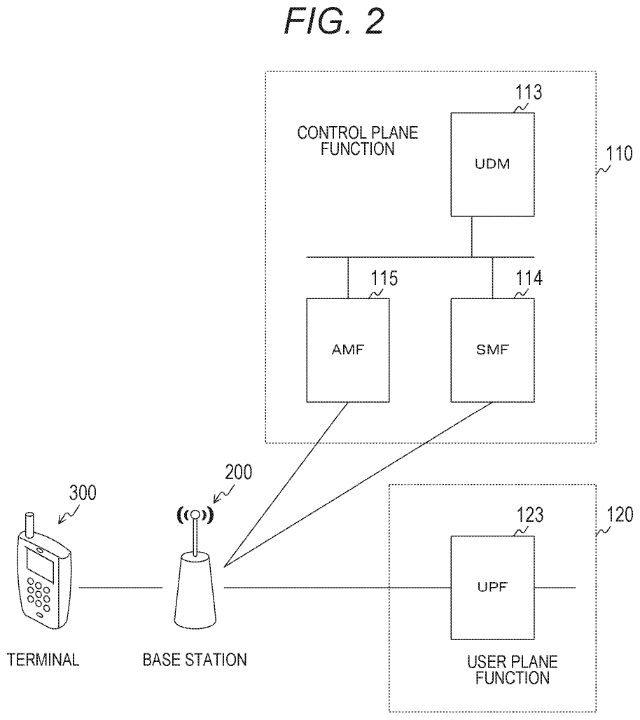

FIG. 2 is a diagram illustrating a second example of the wireless communication system assumed in the embodiment of the present technology.

The second example is an example of a case where the embodiment of the present technology is applied to a fifth-generation mobile communication system (5G). A point that the terminal 300 is connected to the core network via the base station 200 and the terminal 300 and the base station 200 are connected by the RAN is similar to the case of 4G described above.

The 5G control plane function 110 includes a UDM 113, an SMF 114, an AMF 115, and the like. The unified data management (UDM) 113 manages the subscriber information. The session management function (SMF) 114 performs session management. The access and mobility management function (AMF) 115 performs authentication, location management, and the like of the terminal.

The 5G user plane function 120 is not separated unlike the SGW 121 and the PGW 122 in the case of 4G, and is referred to as a user plane function (UPF) 123 herein.

In 5G, the UDM 113 has a function similar to that of the HSS 111. Hereinafter, the notation HSS 111 is used, and it is applicable to the UDM 113. Further, the AMF 115 and the SMF 114 play a role for the terminal 300 to attach to the cellular system.

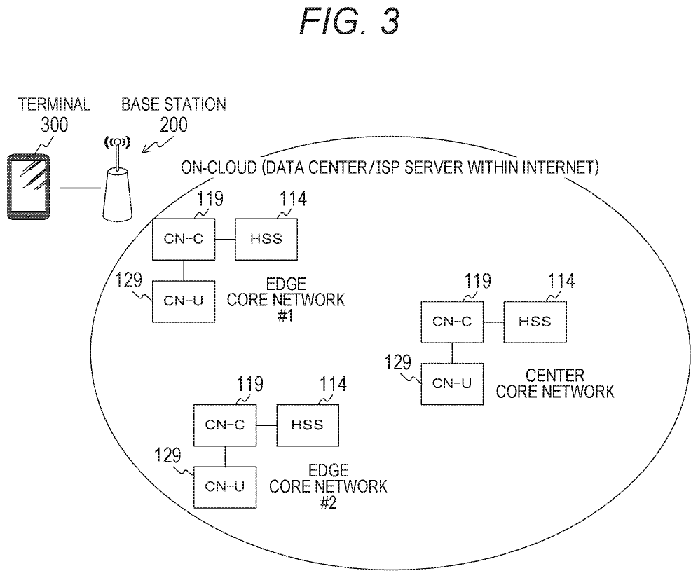

FIG. 3 is a diagram illustrating an example of core network deployment according to the embodiment of the present technology.

The PGW 122 in 4G and the UPF 123 in 5G serve as a gateway serving as a boundary between the core network and the general Internet. In this embodiment, the user plane function of the core network, a CN-U 129, which corresponds to the PGW 122 and the UPF 123, can be regarded as a gateway placed at the boundary between the core network and a general application, since the core network is intended to be deployed also on the general Internet. Similarly, herein, an element corresponding to the MME 112, the SMF 114, and the AMF 115 is indicated as a CN-C 119.

It is known that in a case where the core network is deployed near the terminal 300 and the base station 200, a delay required in a cellular part is reduced. Accordingly, it is expected that the number of core networks deployed at the edge of the Internet increases. However, also in this case, it is useful to deploy the core network not deployed at the edge as a center core network. This is because it is sufficient to use the center core network when the core network is not deployed at the edge.

In the future, it is expected that, in a situation where the center core network is present, many core networks are deployed at the edge of the Internet in various places around the world. In some cases, a core network may be deployed in a LAN in a factory, a hospital, or an office. At least, it is presumable that the base station 200 is installed in a local area such as a factory, a hospital, or an office, and the core network is deployed in such a local area in some cases, and deployed on the Internet near the local area in other cases. In any case, low-cost systems are required in such local cellular systems. They are sometimes referred to as private 4G or private LTE, private 5G, or the like.

[Throughput]

The user plane function implemented by the SGW 121 and the PGW 122, or the UPF 123 has the maximum throughput that can be processed, as an indicator of the capability of the user plane function. For example, it is an indicator indicating that 100 Mbps of user data (user plane data) can be processed, and the like. It is assumed that there is a user plane function of the core network that processes 100 Mbps, and the processing capability of one base station 200 is 100 Mbps. In this case, in a case where one terminal uses the network, that one terminal can enjoy the speed of 100 Mbps. On the other hand, in a case where there are 10 sets of the base station 200 and the terminal, the capability of the user plane of the core network is a bottleneck, so that each terminal can obtain only throughput of 10 Mbps.

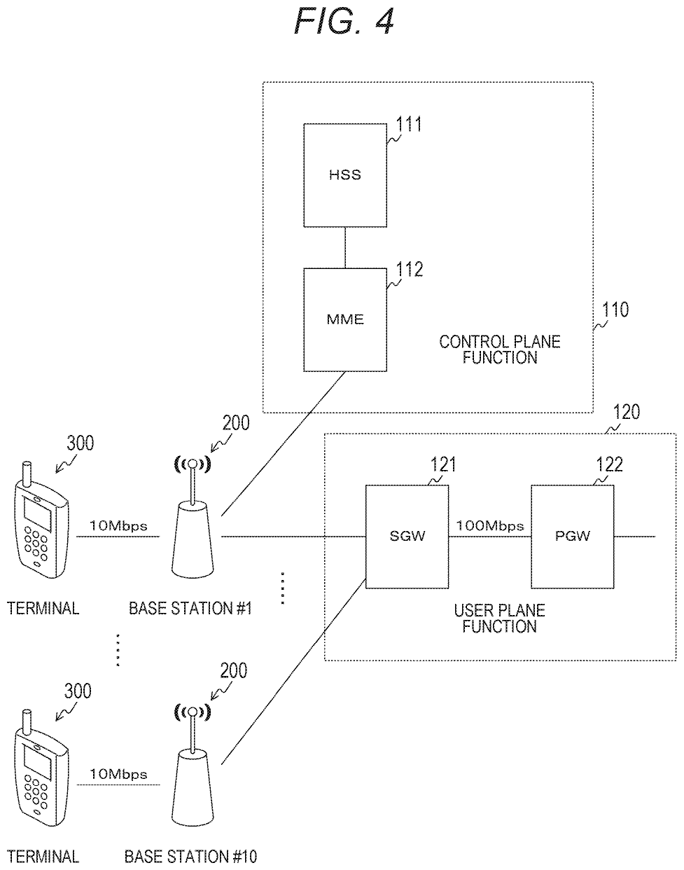

FIG. 4 is a diagram illustrating an example of a case where the core network is a bottleneck. With respect to the user plane function of the core network that processes 100 Mbps, in a case where the number of terminals 300 and base stations 200 increases, there is a possibility that the capability of the user plane is a bottleneck. When the number of base stations 200 and the number of terminals 300 increase as described above, it is necessary to improve the capability of the user plane of the core network.

As the first method of improving the capability of the user plane of the core network, that is, scaling, there is a method of improving the capability itself of a computer that processes the user plane. In a case where the user plane processing is performed by a virtual machine in a cloud data center, the improvement can be achieved by replacing the virtual machine with one having a higher capability. However, in a case where the number of base stations 200 increases by a factor of 10 and the number of terminals 300 increases by a factor of 10, it is impossible to cope with such a large increase by replacement of the capability of the machine itself.

The second method is a method of linearly increasing the function of the user plane. To be specific, the method is a method in which processing performed by one user plane function is performed by 10 user planes. The processing of the terminal 300 and the core network is performed by preparing an earthen pipe for communication called a PDU session for each terminal 300. Therefore, parallel processing by a plurality of user plane functions is possible for each PDU session. Therefore, a better method of scaling is probably a method performed by preparing a plurality of user plane functions.

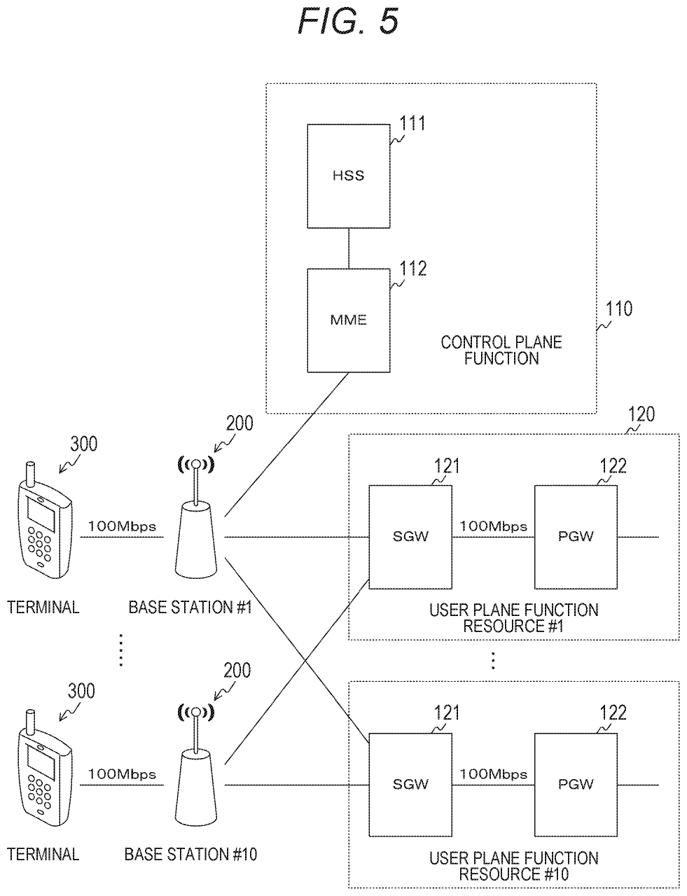

FIG. 5 is a diagram illustrating an example in which the user plane is scaled in the embodiment of the present technology. By preparing 10 resources of the user plane function of the core network that processes 100 Mbps, even if the number of base stations 200 and terminals 300 increases by a factor of 10, the terminals 300 can enjoy the speed of 100 Mbps.

In a case where the user plane of the core network is scaled, static scaling and dynamic scaling are possible. The static scaling is a method in which the number of user planes is fixed once, the core network is started to connect to the base station 200, and after the operation starts, the number of user planes is basically unchanged. On the other hand, the dynamic scaling is a method in which the number of user planes is flexibly increased or decreased in response to a change in the number of terminals 300.

The method of dynamically increasing or decreasing the number of user planes is very difficult. This is because the setting of the base station 200 needs to be changed in some cases, or for example, the function of allocating a new PDU session to the user plane function notices the presence of a changed user plane and updates the internal table, which takes time and effort. Since a core network for a local cellular system, called the private LTE, private 5G, or the like described above, needs to be created at low cost, it has been difficult to take such time and effort. One feature of the embodiment of the present technology is to implement such dynamic scaling at low cost.

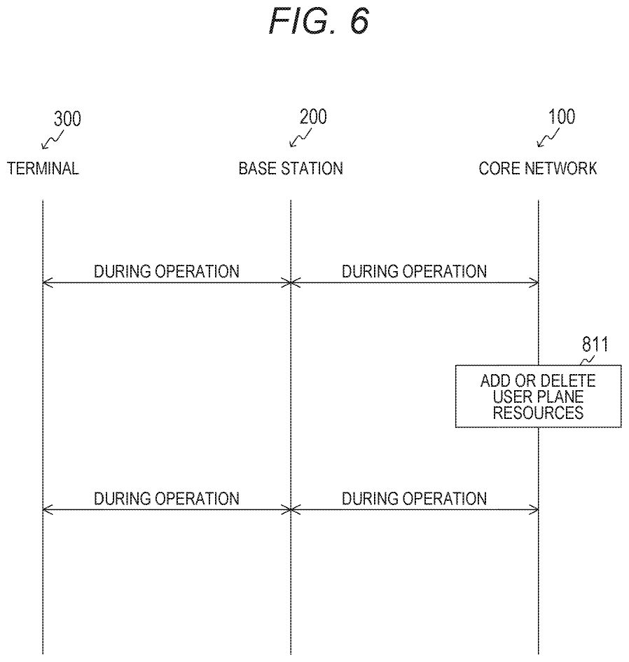

FIG. 6 is a diagram illustrating an example of the dynamic scaling according to the embodiment of the present technology. The example illustrates that resources of the user plane are increased or decreased during operation of the communication system (811).

[Setting File]

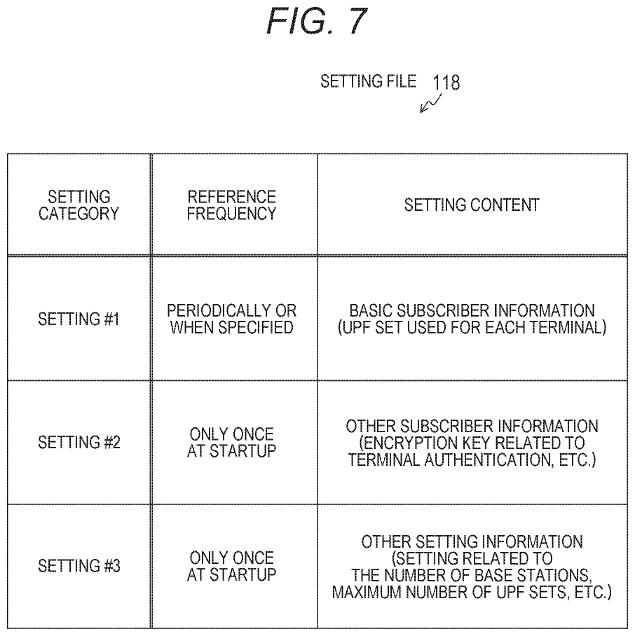

FIG. 7 is a diagram illustrating an example of a setting file 118 according to the embodiment of the present technology.

In order to perform the dynamic scaling of the user plane as described above, the setting file 118 illustrated in FIG. 7 is assumed. The setting file 118 is classified into, for example, three types. “Setting #1” is a part that holds basic subscriber information. The basic subscriber information is information, for each terminal 300, indicating a correspondence relationship with the user plane of the network. “Setting #2” is a part that holds the other subscriber information. The other subscriber information is information such as an encryption key related to authentication of the terminal 300. “Setting #3” is a part that holds the other setting information. The other setting information is information such as settings related to the number of base stations 200 and the maximum number of UPF sets.

Usually, the setting file 118 is referred to at the start of a program of the control plane function, and is read into an internal memory of the control plane program. However, in this embodiment, the basic subscriber information in the “setting #1” is read out periodically even after the start, or, alternatively, is read out at a time specified, and is held in the internal memory. Note that the setting file 118 is an example of a setting information holding unit described in the claims.

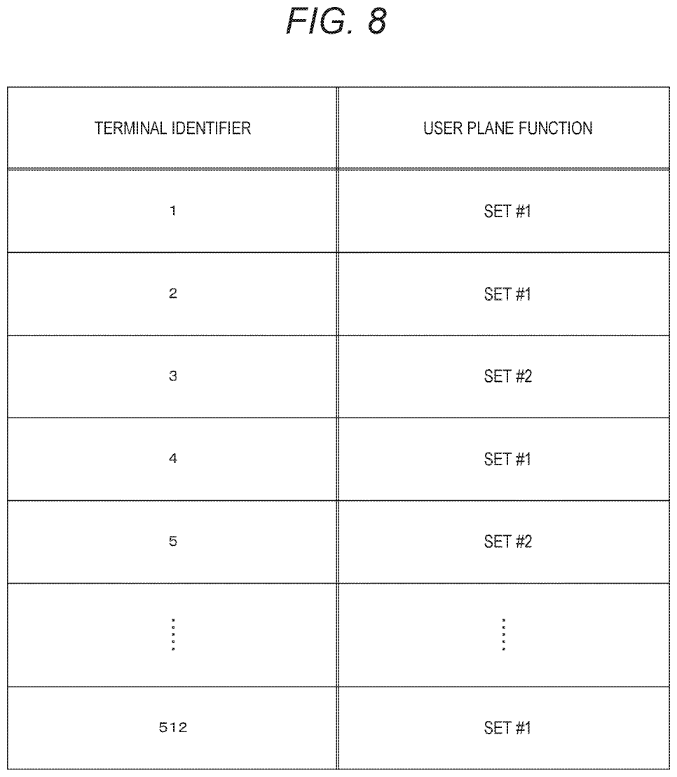

FIG. 8 is a diagram illustrating an example of the basic subscriber information of the setting file 118 according to the embodiment of the present technology.

The basic subscriber information is stored in the network function of the HSS 111 in 4G and the network function of the UDM 113 in 5G. The terminal 300 is identified by a terminal identifier called the IMSI in 4G and a SUPI in 5G. For each IMSI or SUPI, which SGW 121 and PGW 122, or UPF 123 is to be used is designated as the UPF set.

The basic subscriber information can be flexibly set, and for example, the terminal 300 may be unequally allocated to each UPF set.

In addition, by referring to the basic subscriber information in the setting file, it is possible to easily grasp which UPF set is used by the terminal 300.

Here, in order to reduce the load on the control plane function, the program is started assuming that the number of sets of the SGW 121 and the PGW 122, or the UPF 123 is the maximum (for example, 32) from the beginning. Among these, a program of the UPF is started according to a part that designates which UPF set is to be used for each terminal 300 identified by the IMSI or the SUPI (setting #1).

In order to start the program of the UPF, the virtual machine is started and then the program is started thereon. Starting the virtual machine usually leads to billing from a cloud operator; therefore, the virtual machine is started only when the necessity arises and the program is started in the virtual machine.

In this embodiment, a resource management function 190 described later determines addition or deletion of the UPF. Then, a cloud management tool adds or deletes the virtual machine, so that the UPF is actually added or deleted.

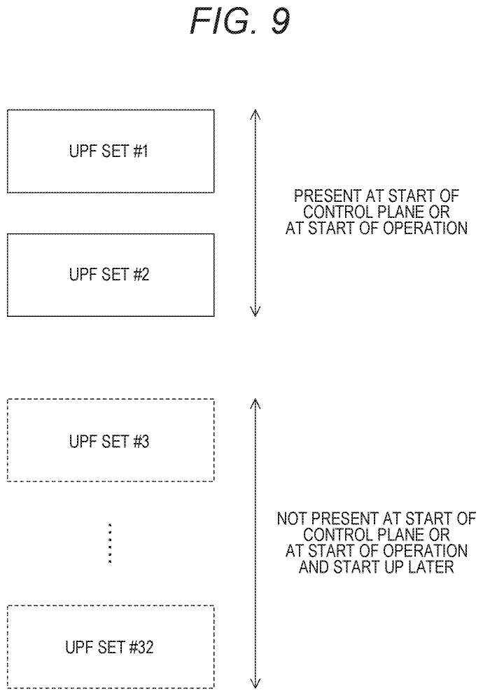

FIG. 9 is a diagram illustrating an example of a start state of the UPF set according to the embodiment of the present technology.

In a case where there are only two sets of UPF sets, number 1 and number 2, each subscriber is prompted to use one of the two sets. Therefore, since one of the two sets is allocated in response to the subscriber attaching to the network, even if the control plane is started from the beginning as being capable of handling 32 sets, they are not specified in the basic subscriber information of the setting file 118. Therefore, a problem of using a UPF set is not actually present does not occur.

In the setting file 118, the part designating which UPF set is to be used for each terminal 300 (setting #1) is read by the program at regular time intervals and taken into the internal memory of the program. Here, the regular time interval is, for example, a time appropriately set such as every 10 minutes or every 1 hour.

The setting file 118 itself may be divided into a plurality of files, and only a part that designates the use of the UPF set for each terminal 300 may be set as a separate file. In other words, the settings #1 to #3 may be separated as different files. The reason why all are read at regular time intervals is that the influence on the running program is large. This enables the program to recognize a change in the basic subscriber information made later, but, only the part of the basic subscriber information needs to be read at regular time intervals, and thus the burden on the control plane program is small.

When the terminal 300 attaches, the MME 112 or the SMF 114 of the user plane function checks the information of the terminal identifier in the basic subscriber information of the setting file 118, and determines which UPF set is to be used. Then, a GTP tunnel for the terminal 300 is established between the base station 200 and the designated UPF set. The “setting #1” is referred to only when the terminal 300 starts the attaching procedure. In practice, when the attaching procedure is performed and a PDU session is allocated for that terminal 300, allocating a UPF set is necessary.

Some core networks implement the attaching and the allocation of the PDU session together while other core networks implement the attaching and the allocation of the PDU session as separate procedures. In this embodiment, the former core network that implements together is described. On the other hand, in the case of a program executed as separate procedures, it is presumably necessary to refer to the content of the “setting #1” read at the allocation of the PDU session.

Here, a difference between the attaching and the PDU session establishment is described. The attaching is a procedure of permitting the terminal 300 to connect to a network and giving an IP address to the terminal 300. The PDU session establishment is a procedure of preparing, for the terminal 300, an earthen pipe for communication based on the GTP protocol between the base station 200 and the UPF.

Note that the attaching processing and the allocation processing of the PDU session are mainly performed by the terminal 300, the base station 200, and the core network.

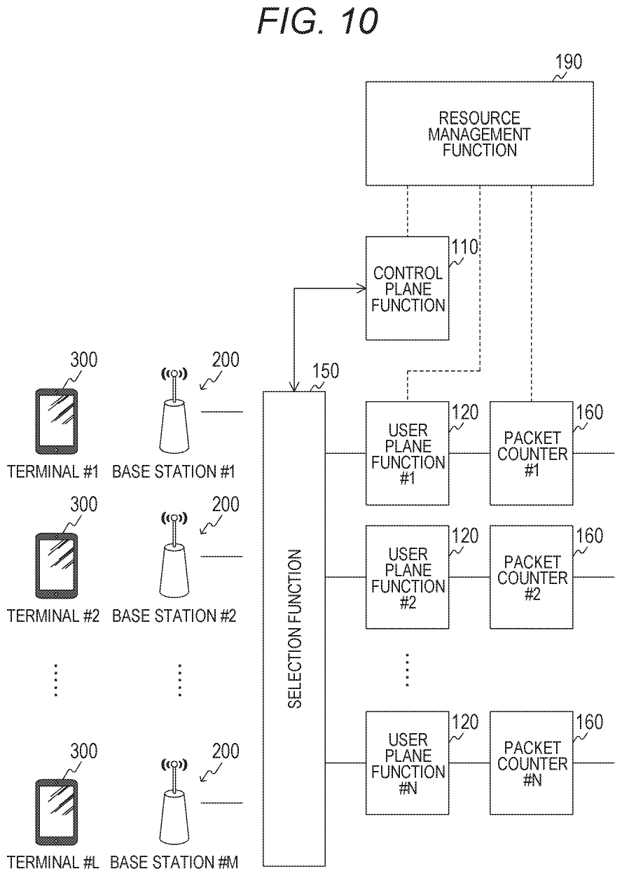

FIG. 10 is a diagram illustrating an example of an aspect of traffic monitoring by the resource management function 190 according to the embodiment of the present technology.

The resource management function 190 is a function to manage resources of the user plane function. The resource management function 190 monitors the traffic of each user plane function by a packet counter 160 that functions as a traffic monitor. Note that packet flow monitoring is a packet monitoring entity, and a resource management entity acquires and determines the information. Note that the resource management function 190 is an example of a control unit described in the claims.

In a case where it is determined that the number of packets flowing to each user plane function increases, the resource management function 190 increases the UPF. Thereafter, the resource management function 190 rewrites information indicating which UPF of the basic subscriber information is to be used, and adds the allocation of the terminal 300 to the newly added UPF. At this point in time, there is no change in the UPF that is being used by the terminal 300. That is, in the allocation of the terminals 300, it is not necessary to consider which terminal 300 is currently in use. The detailed reasons for this are described later.

A selection function 150 of the control plane allocates the terminal 300 and the UPF set. The increase in the UPF set is not reflected in the actual operation until after the next two steps. First, as a first step, the control plane reading the basic subscriber information of the setting file 118 at regular time intervals reads the changed basic subscriber information at the next cycle and captures the same into the internal memory of the running program.

Next, as a second step, in response to the terminal 300 newly attaching, a UPF set is newly allocated from the control plane. That is the first time when the newly rewritten basic subscriber information is valid, and in a case where the basic subscriber information indicates that the terminal 300 newly attaching is to use the newly added UPF set, the terminal 300 is allowed to use the added UPF set.

In this way, only after the conditions of the first step and the second step are satisfied, the UPF set added in response to the change in the basic subscriber information is allowed to be used. The UPF set is used in a radio resource control connected mode (RRC connected mode), and as for the terminal 300 that has entered an RRC idle mode, the same UPF set should be kept. Therefore, according to the policy of referring to new basic subscriber information for the terminal 300 that has attached, it is presumable that the processing of allocating the terminal 300 to the UPF set can be implemented.

[Operation]

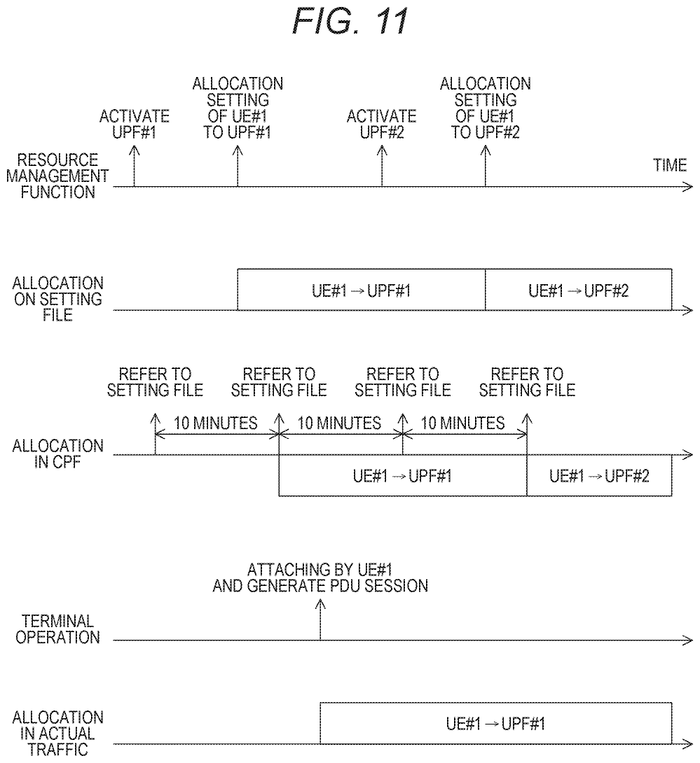

FIG. 11 is a diagram illustrating an example of operation timing of the wireless communication system according to the embodiment of the present technology.

The resource management function 190 activates resources of the UPF #1 and rewrites the resource allocation of the UPF for each terminal 300. At this point in time, nothing changes because it has not been captured in the internal memory of the control plane program.

In this example, since the setting file 118 is read every 10 minutes, the setting file is captured into the internal memory of the control plane program at the next read timing, and the program is in a state of recognizing a change in allocation. There is no change in the allocation even at this timing.

When the terminal 300 attaches in this state, the UPF is allocated as the UPF to be allocated to the terminal 300 according to the content written in the internal memory of the control plane program. Next, even if the allocation of the terminal 300 and the UPF changes, the allocation of the terminal 300 to the UPF #1 does not change while the terminal 300 continues attaching. It is reflected only when the terminal 300 attaches and a PDU session is generated.

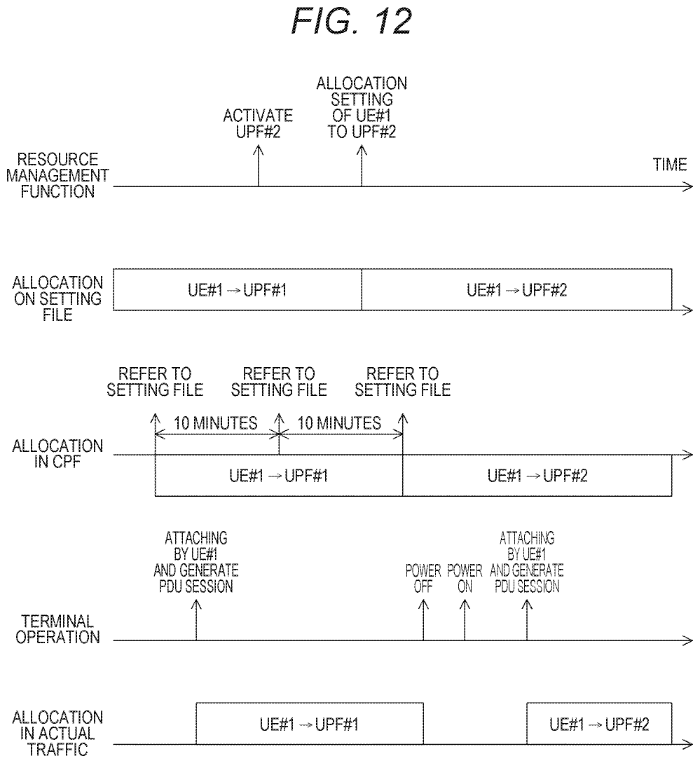

FIG. 12 is a diagram illustrating another example of operation timing of the wireless communication system according to the embodiment of the present technology.

In the example described above, since the terminal 300 is not powered off, the UPF allocated to the terminal 300 is not changed. On the other hand, in this example, the terminal 300 is once turned off and thereafter turned on, so that the allocation of the UPF to the terminal 300 is changed.

In this case also, when the terminal 300 attaches and a PDU session is generated, it is reflected as actual traffic.

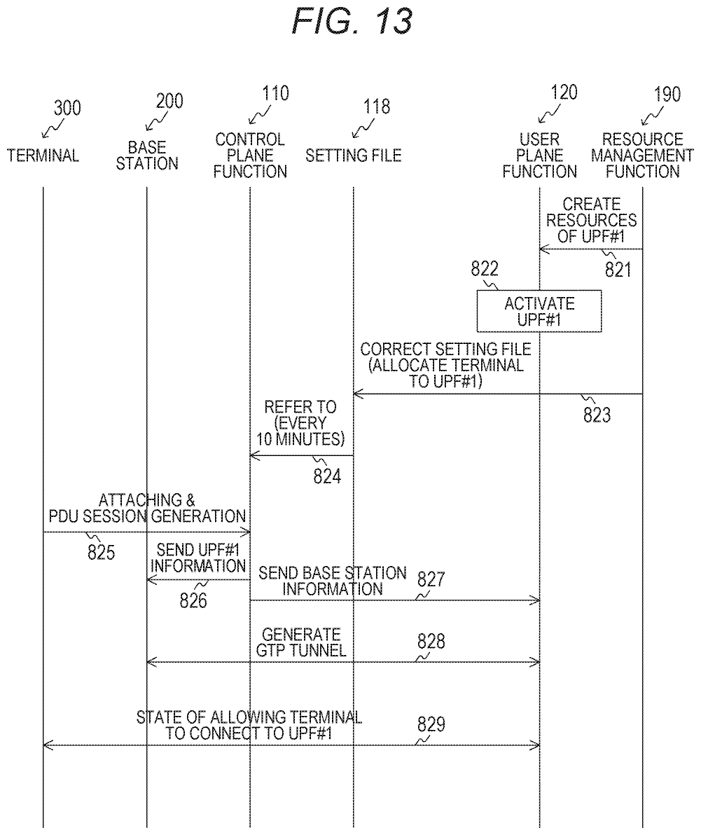

FIG. 13 is a sequence diagram illustrating an example of an operation flow of the wireless communication system according to the embodiment of the present technology.

The operation example illustrates a flow for a case where resources of the user plane increase. The resource management function 190 requests the user plane of the core network to create resources (821). This can actually be regarded as starting the virtual machine from the function that manages the cloud.

The user plane function 120 activates the UPF #1 (822). As a result, in a case where the function of the UPF #1 is actually prepared, the resource management function 190 rewrites the setting file 118 of the control plane function (823). In the rewriting of the setting file 118, the terminal 300 arbitrarily selected is set to use the UPF #1.

Thereafter, the setting file 118 is read by the control plane function main body at a constant cycle, and a change in the setting is recognized in the control plane function (824).

Then, in a case where the terminal 300 attaches and a PDU session is generated (825), the UPF #1 is allocated as an earthen pipe (GTP tunnel) for communication of the PDU session of the terminal 300 (826 to 828). The GTP tunnel is a protocol that builds on a UDP protocol and forms the earthen pipe for communication usually used in 3GPP communication. This enables the terminal 300 to be connected to the UPF #1 (829).

Note that, in this example, since which UPF is to be used for each subscriber is determined in the setting file 118, in a case where the terminal 300 that has attached by chance is set to use a specific UPF, even if another UPF is available, that UPF cannot be used. In this regard, in the private 4G or the private 5G used in the local area, since an administrator can predict the use method of the terminal 300 to some extent, the administrator can appropriately set the setting file 118.

Further, in a case where a terminal 300 that is probably used has already attached once and a PDU session is generated, if there is no terminal 300 to newly attach, the terminal cannot be guided to the newly added UPF. In this case, as described later, the problem can be avoided by putting, in the terminal 300, a program for restarting the attaching and the PDU session generation at regular time intervals. This is a measure for the terminal 300 that has already attached, and no problem arises in the terminal 300 to attach from now.

Further, in the case of a core network in which the attaching and the PDU session generation can be handled completely separately, and in the case of a core network in which the setting file 118 is referred to and a UPF to be used is determined each time the PDU session generation is performed, no problem occurs. The embodiment can be used for both a core network that refers to settings in the attaching and the PDU session generation and a core network that refers to settings even in the PDU session generation alone.

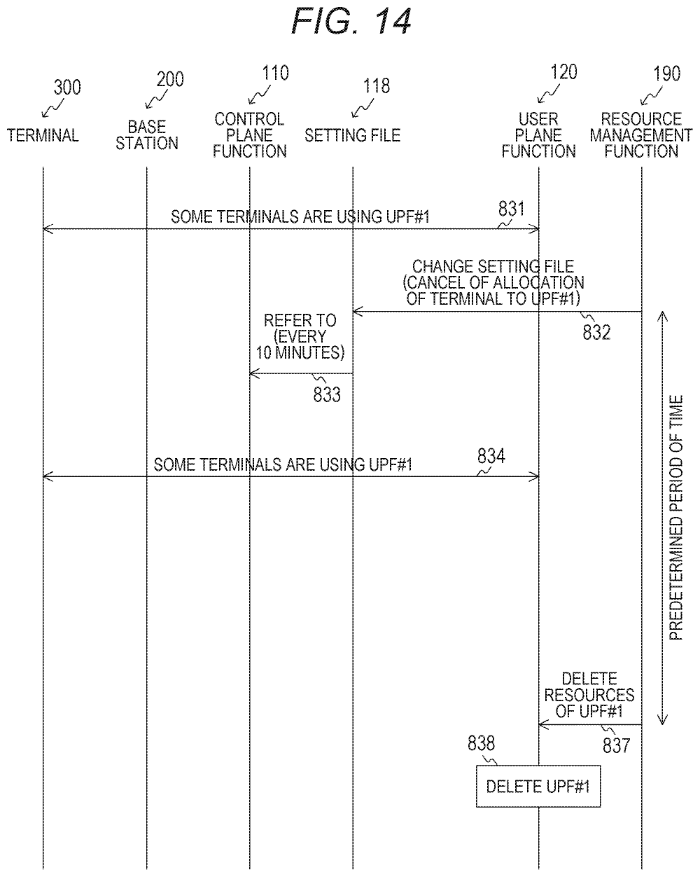

FIG. 14 is a sequence diagram illustrating another example of an operation flow of a wireless communication system according to the embodiment of the present technology.

The operation example illustrates a flow for a case where resources of the user plane decrease. In a case where the number of packets flowing to the user plane function 120 decreases, the resource management function 190 determines which UPF is to be reduced. On the basis of the determination, the information indicating which UPF of the basic subscriber information is to be used is rewritten, and the allocation of the terminal 300 is changed so as to allocate the terminal 300, which has been allocated to the deleted UPF, to the remaining UPF. At this point in time, the UPF is not decreased. Further, at this point in time, there is no change in the UPF used by the terminal 300.

The deletion of the UPF is not reflected in the actual operation until after the next two steps. First, as a first step, the control plane reading the setting file 118 at regular time intervals reads the changed setting file 118 at the next cycle and captures the same into the internal memory of the running program.

Next, as a second step, until the terminal 300 detaches, even if the new setting file 118 is read into the memory of the program in the first step, it is presumable that the terminal 300 continues to use the UPF set that has been used so far until the terminal 300 detaches. However, once the terminal 300 detaches, the setting file 118 is rewritten, so that any one of the reduced UPF sets is allocated. Thus, the timing at which the detaching of the terminal 300 is detected is the issue.

It is desirable that after knowing the detaching of such terminal 300, the virtual machine on the cloud is actually deleted, and the UPF set is deleted. However, such a mechanism for receiving a notification of the detaching of the terminal 300 from the control plane function is complicated, and the mechanism is expensive to design. Thus, a simple means of simply deleting after a certain period of time has elapsed (for example, 1 hour, 1 day, etc.) is effective.

As described above, in the case of a core network in which the terminal 300 confirms again the setting of the UPF to be used each time the PDU session is established again, such a problem does not occur. On the other hand, in a case where such a core network cannot be prepared, it is necessary to delete the UPF after a certain period of time has elapsed.

As described above, it is easy to increase the UPF in accordance with the increase in traffic; however, it is not easy to decrease the UPF in accordance with the decrease in traffic. Basically, it takes time for the terminal 300 to detach. This is because the allocation of the UPF set to the terminal 300 does not change as long as the power is continuously turned on. On the other hand, there is a possibility that modifying the core network to reselect the UPF set for each PDU session leads to the increase in cost.

In this example, it is assumed that several terminals 300 use the UPF #1 (831). At this time, it is assumed that the setting file 118 is changed, and the allocation of the UPF of the terminal 300, which has been allocated to the UPF #1 so far, is changed from the UPF #1 to another UPF #X (832).

Thereafter, the setting file 118 is read in the control plane function main body at a constant cycle, and a change in the setting is recognized in the control plane function (833). The remaining terminals 300 may use the UPF #1 (834).

Then, in a case where the resource management function 190 gives an instruction to delete the resources of the UPF #1 (837), the program of the UPF #1 is stopped, and then the start of the virtual machine on which the UPF #1 operates is stopped (838). In a case where the virtual machine is stopped, the computer resources of the cloud are no longer used, and thus, the cloud provider does not charge in response to the start of the virtual machine, which can reduce the cost.

### 2. MODIFICATION EXAMPLE

### First Modification Example

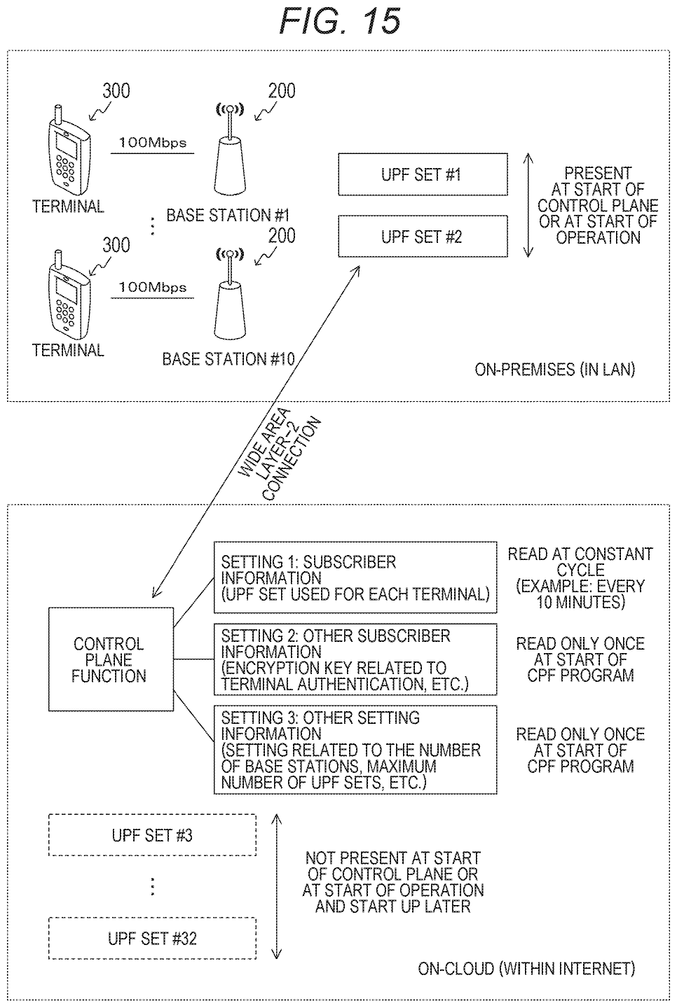

FIG. 15 is a diagram illustrating an example of the wireless communication system according to the first modification example to the embodiment of the present technology.

The wireless communication system assumed in the first modification example is a use case formed across on-premises and on-cloud. The on-premises means that a UPF is deployed on a local area network (LAN) in a factory, a hospital, an office, and so on. The on-cloud means that a UPF is deployed in a cloud data center on the Internet. The base station 200 and the terminal 300 are originally installed in a local area.

The control plane of the core network may be on-premises or on-cloud. Here, an example in which the control plane is installed on-cloud is illustrated.

When the control plane is started, the control plane is started assuming that there are 32 UPFs from the beginning. Two of the 32 UPFs are implemented by a UPF actually started in a personal computer (PC) of hardware on-premises. The remaining 30 UPFs are intended to be used with virtual machines on the cloud added when needed. Note that the PC is an example of a first information processing device described in the claims. Further, the virtual machine is an example of a second information processing device described in the claims.

The LAN and the cloud data center are preferably networked as the same subnet with wide area layer-2 connection. This can increase and decrease the UPF without being conscious of whether it is on the LAN or in the cloud. In a case where the UPFs on-premises are insufficient, the UPFs on-cloud are actually started to increase the capacity of the entire UPFs.

As described above, in the first modification example, the embodiment described above can be applied by connecting the LAN and the cloud data center with wide area layer-2 connection. At this time, it is assumed that the UPFs deployed in the LAN are started from the beginning. Note that an existing technology such as a virtual VPN can be applied as a technology for wide area layer-2 connection.

### Second Modification Example

As described above, even if it is relatively easy to increase the UPF set in accordance with the increase in traffic; however, it is not easy to decrease the UPF in accordance with the decrease in traffic. Basically, it takes time for the terminal 300 to detach. This is because the allocation of the UPF set to the terminal 300 does not change as long as the power is continuously turned on. Modifying the core network to reselect the UPF set for each PDU session leads to the increase in cost. In view of this, a technology for easily implementing the reduction of the UPF set is described.

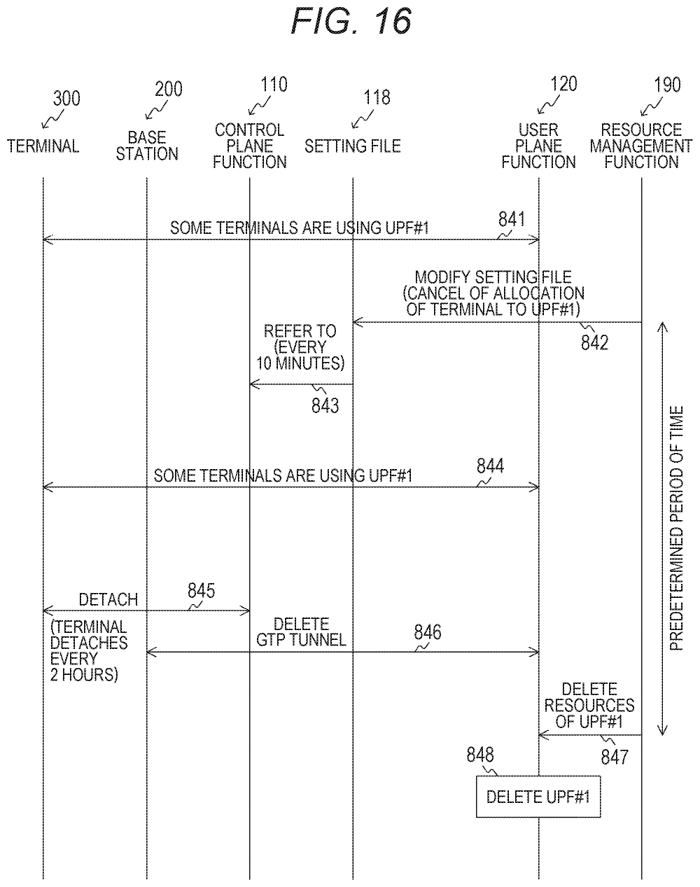

FIG. 16 is a sequence diagram illustrating an example of an operation flow of the wireless communication system according to the second modification example to the embodiment of the present technology.

In the second modification example, an application for turning off/on an airplane mode at regular time intervals is executed in the terminal 300. The airplane mode is a function to prevent transmission of a radio wave when boarding an airplane in an application of a smartphone. When the airplane mode is turned on, the terminal 300 detaches from the network in order to transition to a state in which radio waves are not emitted.

Using the application to turn off/on the airplane mode at a constant cycle (for example, once a day). Thereby, for example, even if the terminal 300 continues to use the UPF set even after the allocation of the terminal 300 to the UPF set is deleted in the setting file, the terminal 300 always detaches after a certain period of time (845), and the GTP tunnel is deleted (846). That is, it can be ensured that the use of the UPF set is discontinued. After a certain period of time, deleting a virtual machine having the function of the UPF set (847) completes the deletion of the UPF set (848).

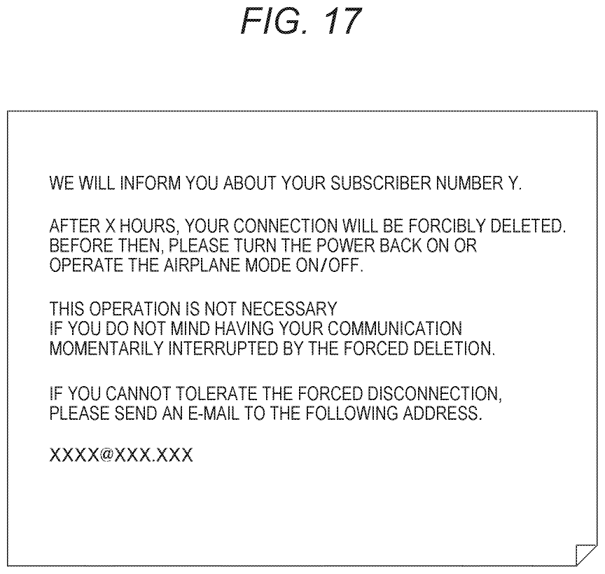

FIG. 17 is a diagram illustrating an example of a message to a user in the second modification example to the embodiment of the present technology.

In the case of forcibly deleting the UPF set as described above, it is useful to convey some form of message to the user to that effect. In this example, an email to the user announces that the connection by the UPF set is forcibly deleted for the subscriber number (IMSI or SUPI) in use.

On the other hand, the user can avoid a situation in which the corresponding UPF set disappears in the middle of communication by turning off/on the air plane mode or turning the power supply back on.

### Third Modification Example

In the embodiment described above, each of the UPF sets is handled equally; however, it is also useful to give priority to each UPF set. For example, it is conceivable that a deletion condition is defined for the UPF set in advance and a terminal 300 that can tolerate the deletion condition is allocated.

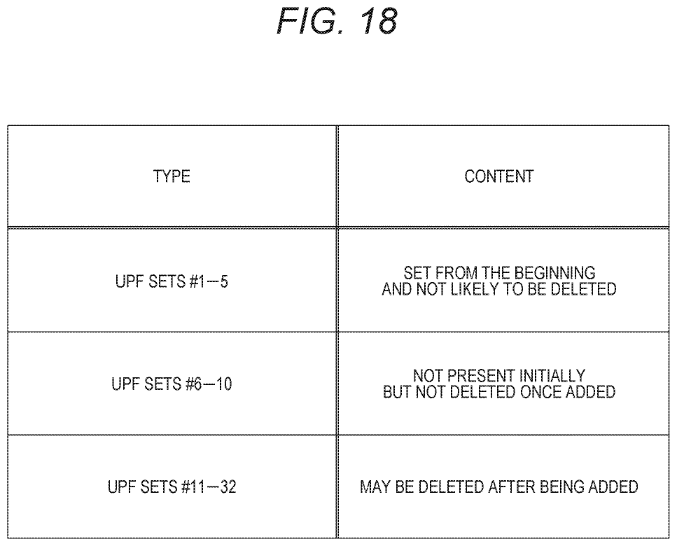

FIG. 18 is a diagram illustrating an example of priority of a UPF set in the third modification example to the embodiment of the present technology.

As illustrated in FIG. 18, for example, it is assumed that the UPF sets #1 to #5 are set from the beginning and are not likely to be deleted. Further, it is assumed that the UPF sets #6 to #10 are not present at first, but are not deleted once added. Further, it is assumed that the UPF sets #11 to #32 may be deleted after being added. That is, since the conditions for deleting the UPF sets are defined, the terminal 300 can be allocated accordingly.

Note that, also in the third modification example, the terminal 300 is allocated to the UPF set in the setting file.

As described above, in the embodiment of the present technology, the resource management function 190 changes the basic subscriber information of the setting file 118, and the control plane program periodically refers to and captures the basic subscriber information into the internal memory. Then, in order to add resources of the user plane, when the terminal 300 attaches and a PDU session is generated, the control plane reflects the resources as the actual traffic. On the other hand, in order to delete resources of the user plane, the control plane deletes the resources of the user plane after a certain period of time has elapsed since the basic subscriber information of the setting file 118 was changed. As a result, it is possible to easily add and delete resources of the user plane and to flexibly control the allocation of the user plane to the terminal 300.

That is, according to the embodiment of the present technology, since the UPF sets (SGW 121 and PGW 122, or UPF 123) can be easily increased or decreased, the cost of the computer used by the user can be reduced. Further, since the number of virtual machines on the cloud can be increased or decreased, the computer cost of the user can be optimized for the traffic situation.

Note that the embodiment described above illustrates an example for embodying the present technology, and the matters in the embodiment and the matters specifying the invention in the claims have a correspondence relationship. Similarly, the matters specifying the invention in the claims and the matters in the embodiment of the present technology denoted by the same names as the matters specifying the invention have a correspondence relationship. However, the present technology is not limited to the embodiment, and can be embodied by making various modifications to the embodiment without departing from the spirit thereof.

Further, the processing procedures described in the embodiment described above may be regarded as a method including the series of procedures, and may be regarded as a program for causing a computer to execute the series of procedures or a recording medium storing the program. As the recording medium, for example, a compact disc (CD), a mini disc (MD), a digital versatile disc (DVD), a memory card, a Blu-ray (registered trademark) disc, or the like can be used.

Note that the effects described in the present specification are only examples and are not limitative ones, or there may be other effects.

Note that the present technology may also be configured as below.

(1) A network control device including:

a setting information holding unit configured to hold, for each terminal, setting information including setting of a correspondence relationship with a user plane of a network; and

a control unit configured to control, after the setting is changed, the network with the setting reflected under a predetermined condition.

(2) The network control device according to (1), in which

the change in the setting is to newly allocate the user plane to the terminal, and

the control unit reflects the setting in a case where the terminal performs a predetermined operation.

(3) The network control device according to (2), in which

the control unit reflects the setting in a case where the terminal performs an attaching operation and a PDU session is generated.

(4) The network control device according to any one (1) to (3), in which

the control unit reads the setting information from the setting information holding unit at predetermined timing to hold the setting information in an internal memory, and reflects the setting under the predetermined condition on the basis of the setting information held in the internal memory.

(5) The network control device according to (4), in which

the control unit reads the setting information from the setting information holding unit at a constant cycle to hold the setting information in the internal memory.

(6) The network control device according to (5), in which

the control unit reads only a part corresponding to the setting of the setting information from the setting information holding unit at the constant cycle to hold the part corresponding to the setting in the internal memory.

(7) The network control device according to any one of (1) to (6), in which

after resources of the user plane are increased, the setting information holding unit holds the setting of allocating the user plane increased to the terminal.

(8) The network control device according to any one of (1) to (7), in which

resources of the user plane are distributed and deployed in a first information processing device in a local area network and a second information processing device on the Internet, and

the first and second information processing devices are connected via a wide area layer-2.

(9) The network control device according to (8), in which

the first and second information processing devices are networked via an identical subnet.

(10) The network control device according to any one of (1) to (9), in which

after a certain period of time has elapsed since deletion of a user plane allocated in the setting held in the setting information holding unit, the control unit deletes resources of the user plane.

(11) The network control device according to (10), in which

before deleting the resources of the user plane, the control unit informs the terminal that the resources of the user plane are to be deleted.

(12) The network control device according to any one of (1) to (11), in which

the setting information holding unit holds setting of a correspondence relationship with the terminal on the basis of conditions regarding deletion of the user plane.

(13) The network control device according to any one of (1) to (12), in which

the control unit deletes allocation of the user plane every time the terminal restarts a communication function at regular time intervals.

(14) A network control method including:

a procedure of holding, by a setting information holding unit, for each terminal, setting information including setting of a correspondence relationship with a user plane of a network; and

a procedure of controlling, by a control unit, after the setting is changed, the network with the setting reflected under a predetermined condition.

(15) A program for causing a computer to execute processing including:

a procedure of holding, for each terminal, setting information including setting of a correspondence relationship with a user plane of a network; and

a procedure of controlling, after the setting is changed, the network with the setting reflected under a predetermined condition.

### REFERENCE SIGNS LIST

110 Control plane function
111 HSS (Home Subscriber Server)
112 MME (Mobility Management Entity)
113 UDM (Unified Data Management)
114 SMF (Session Management Function)
115 AMF (Access and Mobility Management Function)
118 Setting file
119 CN-C(Core Network-Control Plane)
120 User plane function
121 SGW (Serving Gateway)
122 PGW (Packet data network Gateway)
123 UPF (User Plane Function)
129 CN-U (Core Network-User Plane)
150 Selection function
160 Packet counter
190 Resource management function
200 Base station
300 Terminal

1. A network control device comprising:
a setting information holding unit configured to hold, for each terminal, setting information including setting of a correspondence relationship with a user plane of a network; and
a control unit configured to control, after the setting is changed, the network with the setting reflected under a predetermined condition.

2. The network control device according to claim 1, wherein
the change in the setting is to newly allocate the user plane to the terminal, and
the control unit reflects the setting in a case where the terminal performs a predetermined operation.

3. The network control device according to claim 2, wherein
the control unit reflects the setting in a case where the terminal performs an attaching operation and a PDU session is generated.

4. The network control device according to claim 1, wherein
the control unit reads the setting information from the setting information holding unit at predetermined timing to hold the setting information in an internal memory, and reflects the setting under the predetermined condition on a basis of the setting information held in the internal memory.

5. The network control device according to claim 4, wherein
the control unit reads the setting information from the setting information holding unit at a constant cycle to hold the setting information in the internal memory.

6. The network control device according to claim 5, wherein
the control unit reads only a part corresponding to the setting of the setting information from the setting information holding unit at the constant cycle to hold the part corresponding to the setting in the internal memory.

7. The network control device according to claim 1, wherein
after resources of the user plane are increased, the setting information holding unit holds the setting of allocating the user plane increased to the terminal.

8. The network control device according to claim 1, wherein
resources of the user plane are distributed and deployed in a first information processing device in a local area network and a second information processing device on an Internet, and
the first and second information processing devices are connected via a wide area layer-2.

9. The network control device according to claim 8, wherein
the first and second information processing devices are networked via an identical subnet.

10. The network control device according to claim 1, wherein
after a certain period of time has elapsed since deletion of a user plane allocated in the setting held in the setting information holding unit, the control unit deletes resources of the user plane.

11. The network control device according to claim 10, wherein
before deleting the resources of the user plane, the control unit informs the terminal that the resources of the user plane are to be deleted.

12. The network control device according to claim 1, wherein
the setting information holding unit holds setting of a correspondence relationship with the terminal on a basis of conditions regarding deletion of the user plane.

13. The network control device according to claim 1, wherein
the control unit deletes allocation of the user plane every time the terminal restarts a communication function at regular time intervals.

14. A network control method comprising:
a procedure of holding, by a setting information holding unit, for each terminal, setting information including setting of a correspondence relationship with a user plane of a network; and
a procedure of controlling, by a control unit, after the setting is changed, the network with the setting reflected under a predetermined condition.

15. A program for causing a computer to execute:
a procedure of holding, for each terminal, setting information including setting of a correspondence relationship with a user plane of a network; and
a procedure of controlling, after the setting is changed, the network with the setting reflected under a predetermined condition.
